(19) United States
(12) Patent Application Publication
(10) Pub. No.: US 2019/0331118 A1
(43) Pub. Date: Oct. 31, 2019

(54) ELECTRIC MOTOR DRIVEN PUMP

(71) Applicant: GRUNDFOS HOLDING A/S, Bjerringbro (DK)

(72) Inventors: Jan Carøe AARESTRUP, Bjerringbro (DK); Anders Silkær MIKKELSEN, Ry (DK); Carsten CHRISTENSEN, Bagsværd (DK); Simon MØLGAARD MØLLER, Silkeborg (DK); Rasmus Ørndrup NIELSEN, Silkeborg (DK)

(73) Assignee: GRUNDFOS HOLDING A/S, Bjerringbro (DK)

(21) Appl. No.: 16/471,978

(22) PCT Filed: Dec. 15, 2017
(86) PCT No.: PCT/EP2017/083018

§ 371 Date: Jun. 20, 2019

(30) Foreign Application Priority Data
Dec. 21, 2016 (EP) 16205701.2

(51) Int. Cl. F04D 15/00; F04D 13/06; G01D 1/12; G01D 3/024

(52) U.S. Cl. CPC F04D 15/00; G01D 3/024; G01D 1/12; F04D 13/06

(57) ABSTRACT

An electromotorically driven pump (1) includes control electronics (6) for the connection of at least one sensor (5). The control electronics (6) are configured to detect values of an output signal (9) of the connected sensor (5) continuously or in temporal intervals, and after completion of a predefined time, to automatically set a measurement range of the sensor (5) based on the detected values.

### CROSS REFERENCE TO RELATED APPLICATIONS

This application is a United States National Phase Application of International Application PCT/EP2017/083018 filed Dec. 15, 2017, and claims the benefit of priority under 35 U.S.C. § 119 of European Application 16205701.2, filed Dec. 21, 2016, the entire contents of which are incorporated herein by reference.

### TECHNICAL FIELD

The invention relates to an electromotorically driven pump with control electronics which are provided for the connection of at least one sensor.

### TECHNICAL BACKGROUND

Pumps of this type and which are provided with control electronics typically comprise a frequency converter which renders it possible to adapt operating points of the pump in an almost arbitrary manner within a defined power spectrum. For this, a differential pressure sensor for example is provided on the part of the pump. It is particularly with pump systems as well as pumps of a larger construction type, that it is counted as belonging to the state of the art, to connect one or more sensors to the control electronics, in order to control the pump or operate it with a closed-loop control, by way of these sensors.

Thereby, not only is the type of the sensors to be connected very varied, but there are also significant differences even amongst a single sensor type, depending on the field of application. Thus for the control of metering pumps, it is known to measure the flow of the medium, into which a substance, for example a disinfectant, is to be admetered. The pressure which is to be overcome at the delivery side of the pump, in order to be able to deliver, is detected in the case of pumps which feed into a system under pressure or into a geodetic receptacle (water tower, reservoir). With circulation pumps, it can also be necessary to detect the temperature, in order to activate the pumps with regard to power, in dependence on the temperature of the delivery medium, as is counted as belonging to the state of the art with heating circulation pumps.

Since the pump manufacturer designs pumps for the most varied of fields of application and has no knowledge regarding the specific application purpose, for which the pump is to be provided, it is often necessary, on the one hand to select the sensor devices necessary for the operation of the pup and on the other hand to dimension these sensor devices. The latter is often difficult due to the fact that only a rough estimation is possible before starting operation, and a dimensional adaptation of the sensor devices which is actually necessary, is often not effected at later stage for reasons of cost. In practice, this leads to sensors with a much too large measurement range often being selected, with the consequence that they lack the necessary accuracy in the actually required small measurement range.

Although it is counted as belonging to the state of the art, to examine the signals of several sensors with regard to the consistency with the help of a data bank, and if this is not given, to then not use the respective sensor signal for evaluation, as with U.S. Pat. No. 7,624,080 B1, this however does not solve the initially outlined problem.

### SUMMARY

Against this background, it is an object of the invention, to provide an electromotorically driven pump with control electronics which are provided for the connection of at least one sensor, such that the previously mentioned problems are at least reduced.

The electromotorically driven pump comprises control electronics which are provided for the connection of at least one sensor. According to the invention, the control electronics are configured to detect the at least one output signal of the at least one connected sensor, in a continuous manner or in temporal intervals, and after completion of a predefined time, to automatically set the measurement range of the sensor on the basis of the detected values.

Electromotorically driven pumps in the context of the present invention can be a displacement pump, for example a piston pump or membrane pump, for example as part of a metering pump or also of a centrifugal pump, wherein this can be configured in a single-staged or multi-staged manner. The control electronics are typically part of converter electronics, and typically of a frequency converter in the case of centrifugal pumps.

A sensor in the context of the present invention is typically to be understood as a sensor element, for example a strain gauge, which cooperates with sensor electronics, said sensor electronics providing a sensor signal, typically a voltage or also a current, which can be utilized in the control electronics for control and/or regulation purposes. Thereby, for realizing the present invention, it is of no significance as to whether the sensor element and sensor electronics are configured separately as a subassembly or whether the sensor electronics already form part of the control electronics.

Basically, any sensor which is suitable in any manner can be connected to the pump according to the invention. Advantageously however, it is the case of a sensor which detects measurable characteristics of fluids. In particular, a pressure sensor, a differential pressure sensor, a temperature sensor, a sensor for detecting the pH value or a sensor for detecting the through-flow are to be mentioned in this context.

A basic concept of the solution according to the invention, is to detect the output signal of the at least one connected sensor, either continuously or in temporal intervals, and after completion of a predefined time, to automatically set the measurement range of the sensor on the basis of the detected readings. Preferably, the detection is effected in a continuous manner, wherein it is useful to select the temporal interval or intervals, in which an adaptation of the measurement range of the sensor is effected, on the one hand in such a short manner that the adaptation is effected sufficiently rapidly and on the other hand to select it such that it is sufficiently long, so that all sensor events which are or be expected in practice occur to a high probability. This will be different depending on the pump type, and according to the invention, it is conceivable to configure this predefined time such that it can be adjusted at the control electronics of the pump, in order to permit an individual adaption in the case that this should be necessary.

In contrast, as a rule it is more favorable, by way of a suitable algorithm, to ensure that the adaptation of the measurement region is examined, and reassessed as the case may be, by the control electronics, initially at comparatively short time intervals and on later operation at comparatively longer intervals.

Thus according to an advantageous further development of the invention, one envisages designing the control electronics of the pump such that the measurement range of the at least one sensor, in predefined time intervals is automatically examined by the control electronics on the basis of the values which are detected in a time interval, preferably in the last preceding time interval, and is adapted upwards and/or downwards on exceeding a predefined value. Thereby, with regard to the adaption, it is important for this to not only adapt into a further restriction of the measurement range, but also of being capable of widening (broadening) this range again, as the case may be. For example, with temperature sensors in a heating facility, it can last up to a half or three-quarters of year until the sensor has run through all temperatures which are expected on operation. Pressure sensors of pumps which are applied in waste-water systems and whose capacity is not fully utilized until there is flooding, likewise behave in a similar manner.

For this, in a further development, the invention envisages designing the control electronics of the pump such that the setting of the measurement range is not adapted, but set afresh, as with starting operation for the first time, when the values detected in the preceding time interval lie at the lower and/or upper limit of the set measurement range, for a summed time duration of more than 5% to 25% of the time interval. The values of 5% to 25% have been found to be practical, but can also lie below this depending on the field of application, and for certain applications it can be critical if the upper or lower limit of the set measurement range is reached at all. Values for a summed time interval e.g. more that 5% of the time interval are to be understood in that the values which are detected in the time interval lie at a limit of the set measurement range for a time duration of 5% of the time interval. Since the measurement range has already been set beforehand, the detected values cannot exceed this. To a high probability, it is thus to be assumed that when the limit of this measurement range is reached, the actual values lie beyond the previously set limits of the measurement range.

The control electronics of the pump are preferably configured to not only automatically detect and set which is to say adapt the measurement region of the at least one sensor connected thereto, but preferably the control electronics is configured to automatically detect when a sensor has been connected and preferably furthermore to also detect and register the type of sensor concerned. Alternatively or additionally, the control electronics can be envisaged for external data input, which is to say that this data input is either effected by way of suitable setting means at the pump, or for example by an app on a smartphone, tablet or mobile computer, which are configured for communication with the control electronics.

The control electronics are preferably configured for automatically determining the sensor, which is effected on connecting the sensor or on switching on the pump for the first time. Thereby, advantageously not only is the type of sensor detected, but also an identification characterization and/or the current measurement range of the sensor. Typically, on connecting a sensor going into operation for the first time, the maximum possible measurement range is set, which then forms the current (currently present) measurement range.

It is particularly advantageous if the control electronics of the pump are configured to adapt the amplification of the sensor signal in accordance with the set measurement range. The adaptation is advantageously effected in a manner such that the set measurement range is utilized as completely as possible. If for example a pressure sensor, whose sensor element is configured for a measurement range of 0 to 10 bar, is set by the control electronics to a measurement range of 0 to 2 bar, then it is useful to adapt the amplification of the sensor signal such that a sensor signal as would otherwise be the case at 10 bar, already arises at 2 bar. The measuring accuracy in the set measuring range can be increased by way of this.

In an analogous manner, it is advantageous to design the control electronics to adapt the offset of the sensor signal in accordance with the set measurement range. If for example a pressure sensor, whose sensor element is suitable for measurements of 0 to 10 bar, is set to a measurement range of 5 to 7 bar, then it is usefully to put the offset at 5 bar, which is to say to set the zero-point of the measurement range at 5 bar. Offset in the context of the present invention is also bias. Although it is advantageous to set the offset, thus the adaptation of the zero-point after the effected amplification, this however can alternatively also be effected by way of the bias being adapted accordingly, which is to say the zero-point shift is adapted before the amplification of the measuring signal.

The pump according to the invention can advantageously be a metering pump, for example for metering disinfectant into the water of a swimming pool. Here for example, a chlorine sensor, a pH sensor and a pressure sensor can be connectable as sensors.

The pump can alternatively be a centrifugal pump, preferably a wet-running centrifugal pump, as is applied for circulating/delivering fluids in heating and air-conditioning facilities, but also with regard to the water supply. Such a centrifugal pump for example can be a multi-stage centrifugal pump of a pressure-increasing facility or of a water supply facility for a block of flats or for a town district. Such a centrifugal pump can also be part of a waste-water system. There are no limits to the applications, and the sensor devices which can be applied are manifold.

If the control electronics of the pump comprise a closed-loop control, as is regularly the case with pumps controlled by frequency converter, it is particularly advantageous if the sensor, whose measurement range is automatically set by the control electronics, is then provided for detecting a control variable, for example the pressure, the differential pressure or the volume flow. As described further above, a completely automated sensor identification can be provided by the control electronics. In practice however, it is the case that a part-automated sensor identification is provided in the control electronics, so that a part of the sensor data or also a part of the expected operating data, for example of the expected measurement range, can be inputted on the part of the control electronics. For this, it is advantageous to provide an input appliance which is connected to the control electronics in a preferably wireless manner and with which this data can be inputted. Typically, this can be effected via a smartphone, tablet or another mobile computer.

A suitable communication module, for example an infrared module, WLAN module, a Bluetooth module or a mobile radio communication module which has the known mobile radio communication standard, for example 3G, 4G, 5G, is provided in the control electronics, in order to permit a wireless data communication. Such a data communication can also serve for the control, and, as the case may be, for the adaptation of the applied measurement range, and then an external input possibility can also additionally be provided, apart from the automatic measurement range adaptation or alternatively to this. For this, on the part of the computer, it is useful to provide a corresponding software application (app), which on the one hand permits a largely automated data communication with the control electronics of the pump and which furthermore permits the necessary inputs, displays, controls or the like.

It is particularly advantageous if a software program is provided for this, said software program comprising a dialogue query for the input of data which concerns the facility and which is necessary for the operation of the respective sensor, so that the measurement range of the sensor is already set in a useful manner, in particular on first starting operation, whereupon the automated adaption is then effected. Such a dialogue query can be assisted by a data bank, wherein the data bank is usefully cloud-based, so that it is accessible by way of data communication, be it by the control electronics and/or the input appliance.

It is particularly advantageous if a pressure sensor, in particular a differential pressure sensor which for example detects the differential pressure between the entry and exit of the pump is applied.

The sensor can advantageously be a temperature sensor, whose sensor signal typically requires a signal processing, and the inventive automatic setting of the measurement range is particularly advantageous for this.

The invention is hereinafter explained in more detail by way of one embodiment example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 is a circuit diagram of a hydraulic system;

FIG. 2 is a schematic circuit diagram concerning the construction of a sensor;

FIG. 3 is a view of graphs showing an adaptation of the measurement range of a pressure sensor;

FIG. 4 is a view of graphs showing how the adaptation of the measurement range affects the measurement;

FIG. 5 is a diagram showing the adaptation of amplification and offset.

### DESCRIPTION OF PREFERRED EMBODIMENTS

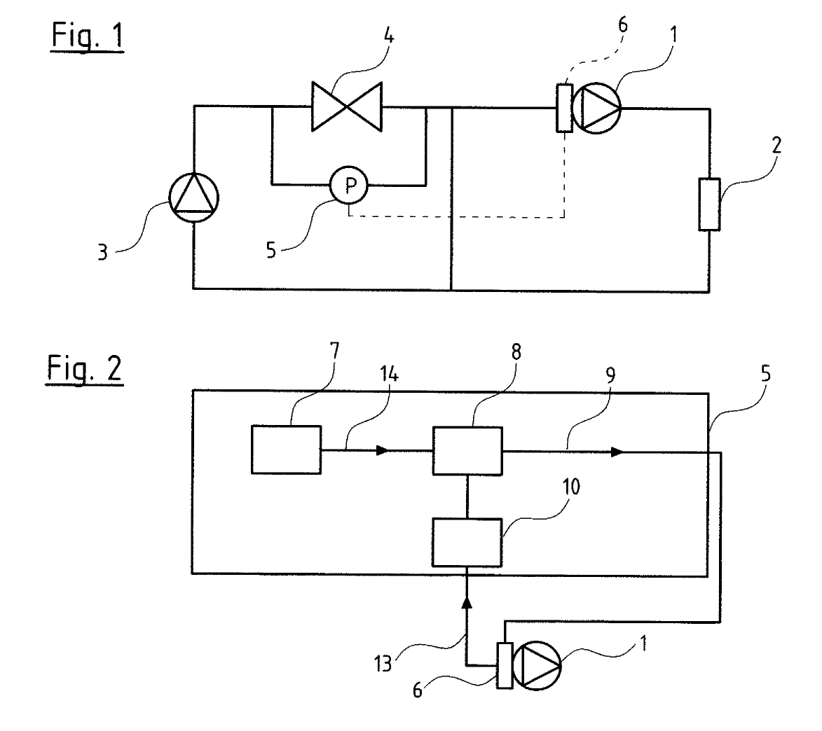

Referring to the drawings, FIG. 1 by way of example shows a hydraulic circuit, with a first pump 1 which delivers to a consumer 2, whose exit is connected to the entry of the pump 1 as well as to the entry of a second pump 3, at the exit of which second pump a valve 4 connects, said valve connecting the exit of the second pump 3 to the entry of the first pump 1.

A pressure sensor 5 is arranged parallel to the valve 4. This pressure sensor 5 is a differential pressure sensor which detects the pressure drop at the valve 4. The sensor 5 is connected to control electronics 6 of the pump 1 which form part of frequency converter electronics of an electric motor driving the centrifugal pump 1.

The control electronics 6 are configured on the one hand to recognize the connected pressure sensor 5 as a pressure sensor and on the other hand to set the measurement range of this pressure sensor 5, as is described further below. The electrical signal of the pressure sensor 5 corresponds to a measured pressure and forms the control variable of a control loop, said control loop being part of the control electronics 6 and whose correcting variable is varied by way of corresponding activation of the pump 1.

As the circuit diagram according to FIG. 2 illustrates, the pressure sensor 5 comprises a sensor element 7, whose output signal 14 is processed by way of sensor electronics 8, whose output forms the actual sensor signal 9.

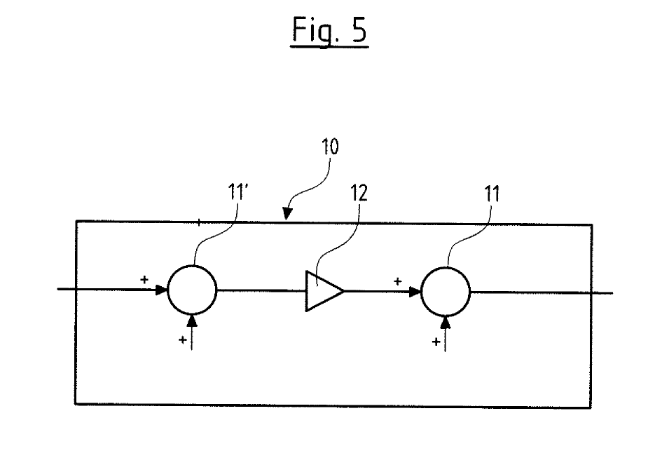

Here, the sensor signal 9 is a voltage signal, wherein a certain pressure value is assigned to each voltage value, depending on the measurement range. Part of the sensor electronics 8 is the part 10 which is symbolized in FIG. 2 and which is represented in detail in FIG. 5 and which after setting a measurement range, serves for adapting the offset 11/bias 11′ and the amplification 12. The sensor signal which is transferred from the sensor electronics 8 to the control electronics 6 is characterized at 9 in FIG. 2.

A control signal is characterized at 13. This is the signal 13 which is sent from the control electronics 6 to the sensor electronics 8, for setting the measurement range as well as the offset 11 or bias 11′ and the amplification 12. Even if the sensor electronics 8 are assigned to the pressure sensor 5, as is described and represented by way of FIG. 2, these sensor electronics or at least parts thereof can also be assigned to the control electronics 6.

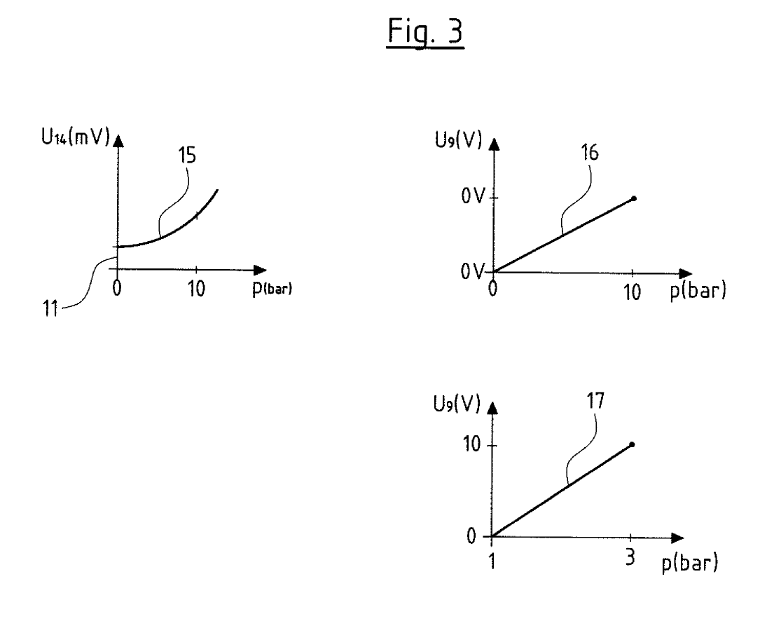

By way of example, an adaptation of the measurement range of the pressure sensor 5 is represented by way of FIG. 3. The sensor element 7 delivers a voltage signal in the millivolt range, depending on the pressure which prevails at the sensor element 7 and which can lie between 0 and 10 bar. As the curvature of the curve 15 representing the characteristic curve of the sensor element, thus the relation between pressure and voltage of the sensor element signal 14 illustrates, the course of the signal is not linear over the measurement range. This is compensated by way of the sensor electronics 8. The offset 11 of the sensor element signal 14 which lies at a few millivolts is likewise compensated by way of the sensor electronics 8. The sensor electronics 8 moreover amplifies the measurement signal, so that a signal which corresponds to the curve 16, lies between 0 and 10 Volts and to which a pressure between 0 and 10 bar is linearly assigned, results at the output of the sensor electronics 8, thus at the output of the pressure sensor 5. The curve 16 thus forms the characteristic curve of the sensor 5.

After the connection of the sensor 5 onto the control electronics 6, and the identification and registration of the sensor 5 in the control electronics, the sensor signal 9 is continuously detected and stored after starting operation of the pump. Alternatively, this can also only be effected at temporal intervals, by way of the sensor signal being enquired and stored for example every five seconds. This is effected over a predefined time of for example two hours, two days or the like. This predefined time can be set on the part of the control electronics. Thereby, the storage of the sensor signal 9 is preferably only effected with regard to the maximal and minimal values. Here therefore, a register for the maximal value and a register for the minimal value are sufficient, wherein in each case it is examined as to whether the current (currently present) sensor signal exceeds the registered maximal value or falls short of the registered minimal value. In this case, the register is replaced by the current sensor signal, otherwise it remains unchanged. After the completion of the predefined time, the register values, as the case may be with a safety margin, are used for setting the measurement range. This measurement range which is determined on the part of the control electronics 6 is transmitted into the sensor electronics 18 by way of a control (command) signal 13.

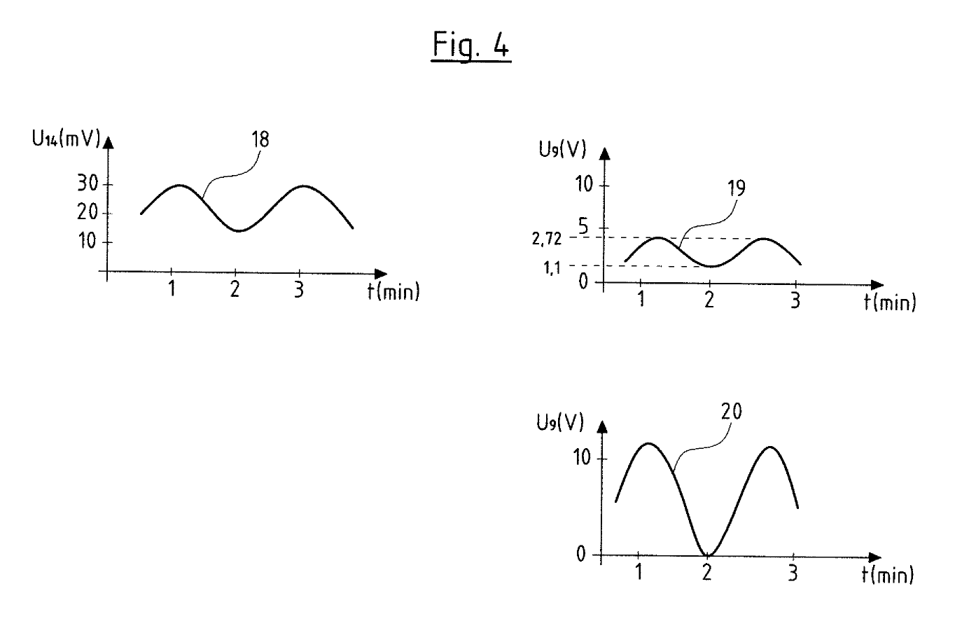

With the embodiment example represented by way of FIG. 4, voltages between 1.1 volts and 2.72 volts (corresponding to curve 19) have been determined in the first time interval (in the predefined time) after starting operation. The measurement range as a result of this is then set to 1 to 3 bar on the basis of these values, after taking into account a 10% safety margin, wherein the sensor electronics 8 are adapted such that a linear signal course between 0 to 10 volts of the sensor signal 9 is produced in the pressure range between 1 bar and 3 bar. As the curve 17 shows, not only has the measurement range been set on the basis of the previously determined sensor signals 9, but the offset 11 has also been adapted, which is to say that the curve 17 has been adapted such that a 0 volt sensor signal corresponds to a pressure of 1 bar at the sensor element 7. Moreover, the amplification 12 has been adapted such that the voltage range between 0 and 10 volts which the sensor electronics 8 can produce, has being divided linearly onto the measurement range of 2 bar, specifically between 1 bar and 3 bar.

This adaptation process from curve 16 to curve 17 is effected by the control electronics 6 of the pump 1, in dependence on the sensor signals 9 received within a predefined time.

This procedure is repeated automatically by the control electronics 6 after the completion of the predetermined time intervals, wherein then basically three possibilities are given:
1. The register values have remained the same, and then no change of the measurement range is effected.
2. If the register values have risen with regard to the minimal value and/or have dropped with regard to the maximal value, then a corresponding adaptation of the measurement range into a smaller measurement range is effected. The offset 11 and the amplification 12 are adapted accordingly.
3. If however the registers have a value in the region of the here 10% safety margin, then the initial method for setting the measurement range is repeated as initially described.

One can differentiate yet further by temporally acquiring readings, which is to say be way of a temporal spreading the registers, by way of it not only being determined on the part of the register as to what the maximal value and the minimal value is, but over what temporal duration, with respect to the time interval, these values have been attained. Thus for example one can specify an initial reading adaptation only being effected when the maximal value and/or the minimal value has been reached over at least 5% of the interval time, when brief peaks which lie outside the set measurement range, can be tolerated with regard to the measuring accuracy of the remaining readings.

A sensor element signal 14 over time, a thereby resulting sensor signal 9 over time, as well as a measuring signal course resulting after the subsequently effected setting of the measurement range as well as the offset adaptation and amplification adaptation, are represented by way of example by way of FIG. 4. The curve 18 which shows a temporal course of the sensor element 14 over 3.5 minutes, results in signal magnitudes between 15 and 28 millivolts. This sensor element signal 14 according to curve 18, as described beforehand, is linearized and amplified by way of the sensor electronics 8, so that a signal course according to curve 19 results, with which the sensor signal 9 moves in the voltage range between 1.1 and 2.72 volts over the represented time of 3.5 minutes. The previously described setting of the measurement range, the adaptation of the offset 11 as well as the amplification 12 is then effected after completion of this time interval, with the knowledge of the maximum and minimum of the signal course over this time interval (the predefined time), so that a curve 20 results and this curve utilizes the complete signal range between 0 and 10 volts and has thus undergone an application-specific adaptation which significantly increases the measuring accuracy.

Thereby, the adaptation and setting of the measurement range is effected in a manner such that the minimal value of 1.1 volts which is reached at roughly 2 minutes on the curve 19 represents the zero point of the curve 20, and the maximal value at the point on time 2.5 of the curve 19 which lies at approx 2.72 volts is represented by a maximal value of 10 volts of the sensor signal 9.

An initial setting of the measurement range is to be understood as the setting of the measurement range which is carried out for the first time in an automatic manner by the control electronics 6 of the pump 1. Such a renewed initial setting of the measurement range, as described further above, can be necessary if, on the basis of the readings detected in a time interval, it results that the measurement range needs to be widened.

The setting of the predefined time after the completion of which such an initial measurement range setting of the control electronics 6 is effected, can be adjusted, just as the time of the subsequent time intervals, after which the measurement range is examined. The registration of the sensor can also take its course in the pump electronics in a fully automatic or partly automatic manner, and inputs are likewise necessary for the latter procedure. These inputs can other be effected at the pump itself, which is to say typically at buttons or other key elements which are provided on the control electronics housing for this, but preferably however in a wireless manner by way of an input device, for example by way of a smartphone or tablet and in a software-assisted manner, by way of a corresponding app being started on the input appliance, said app enquiring these inputs in a targeted manner and transferring them to the control unit. Such a wireless data transmission, in a direct form or also indirectly via an external server whilst utilizing a cloud-based data bank, is nowadays counted as belonging to the state of the art and are is therefore not described in detail.

While specific embodiments of the invention have been shown and described in detail to illustrate the application of the principles of the invention, it will be understood that the invention may be embodied otherwise without departing from such principles.

1. An electromotorically driven pump comprising:
at least one sensor providing at least one output signal; and
control electronics connected to the at least one sensor and configured to detect values of the at least one output signal of the at least one connected sensor, in a continuous manner or in temporal intervals, and after completion of a predefined time, to automatically set a measurement range of the sensor on the basis of the detected values.

2. A pump according to claim 1, wherein the control electronics are configured to automatically examine and adapt the measurement range of the at least one sensor in predefined time intervals, on the basis of the values which are detected in a time interval.

3. A pump according to claim 2, wherein the control electronics are configured to carry out another setting of the measurement range, when the values detected in a preceding time interval lie at a lower limit of the set measurement range or lie at an upper limit of the set measurement range, for a summed time duration of more than 5% to 25% of the time interval.

4. A pump according to claim 1, wherein the control electronics are configured to register the connected sensor, automatically or by way of an external data input.

5. A pump according to claim 1, wherein the control electronics are configured for automatically determining a type of the sensor, or determining an identification characterisation of the sensor or determining a current measurement range of the sensor or determining any combination of a type of the sensor, an identification characterisation of the sensor and a current measurement range of the sensor.

6. A pump according to claim 1, wherein the control electronics are configured to adapt an amplification of the sensor signal in accordance with the set measurement range.

7. A pump according to claim 1, wherein the control electronics are configured to adapt an offset (11) of the sensor signal in accordance with the set measurement range.

8. A pump according to claim 1, wherein the pump is a metering pump.

9. A pump according to claim 1, wherein the pump is a centrifugal pump, in particular a wet-running centrifugal pump.

10. A pump according to claim 1, wherein the control electronics comprises a closed-loop control and that the sensor is provided for detecting a control variable.

11. A pump according to claim 1, wherein the control electronics are configured for the wireless input of sensor parameters.

12. A pump according to claim 11, wherein the control electronics comprise means for wireless data communication and can be set by way of a wirelessly connected input appliance.

13. A pump according to claim 12, wherein the input appliance is a smartphone or tablet computer, on which a software program is installed, via which a data communication with the control electronics of the pump is effected.

14. A pump according to claim 13, wherein the software program comprises a dialogue query for input of data concerning a facility, said data being necessary for the operation of the sensor.

15. A pump according to claim 1, wherein the sensor is a pressure sensor.

16. A pump according to claim 1, wherein the sensor is a temperature sensor.
